(19) United States
(12) Patent Application Publication
(10) Pub. No.: US 2007/0221306 A1
(43) Pub. Date: Sep. 27, 2007

(54) Reinforcement layer on sidewalls of tires

(76) Inventor: Ying-Ming Yang, Taichung City (TW)

Correspondence Address: PHILLIP LIU, 6980, WHITEOAK DR., RICHMOND, BC, V7EAZ9, CA

(21) Appl. No.: 11/389,189

(22) Filed: Mar. 27, 2006

(51) Int. Cl. B60C 13/00

(52) U.S. Cl. 152/525; 152/524

(57) ABSTRACT

A tire includes a tread portion with two sidewalls integrally connected thereto and each of the sidewalls includes a lip so as to be engaged with a wheel rim. Two reinforcement layers are respectively secured on two respective outsides of the two sidewalls and each reinforcement layer is composed of adhesive, mineral particles and/or metal particles. The reinforcement layer has a smooth outer surface and efficiently prevents being penetrated by foreign objects.

### FIELD OF THE INVENTION

The present invention relates to a tire having two reinforcement layers secured on two respective outsides of the sidewalls so as to prevent penetration by sharp objects.

### BACKGROUND OF THE INVENTION

A conventional tire generally includes a tread portion, two sidewalls and two lips which are connected to the sidewalls. The lips are engaged with wheel rim to secure the tire on the rim and the tread portion includes specific patterns for providing better grasping and other functions such as expelling mud, water or snow. It is known that the sidewalls are the weakest parts of the tire and most of the penetration is happened on the sidewalls. Besides, when the vehicles turning, the sands hit on the sidewalls also generate huge noise.

The present invention intends to provide a tire which includes two reinforcement layers secured on two respective outsides of the sidewalls and the reinforcement layers includes adhesive, mineral particles or metal particles such that foreign objects cannot penetrate through the reinforcement layers.

### SUMMARY OF THE INVENTION

The present invention relates to a tire which comprises a tread portion with two sidewalls integrally connected thereto and each of the sidewalls includes a lip to be engaged with a wheel rim. Two reinforcement layers are respectively secured on two respective outsides of the two sidewalls and each reinforcement layer is composed of adhesive, metal particles and/or mineral particles.

The primary object of the present invention is to provide a reinforcement layer which is adhered on the outside of each of the sidewalls of a tire so as to prevent from penetration by foreign objects.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a cross sectional view of a tire with the reinforcement layers of the present invention, and

FIG. 2 is a perspective view to show a section of the tire with the reinforcement layers of the present invention.

### DETAILED DESCRIPTION OF THE PREFERRED EMBODIMENT

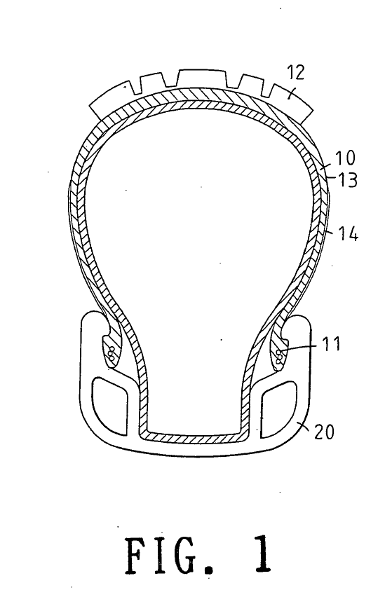

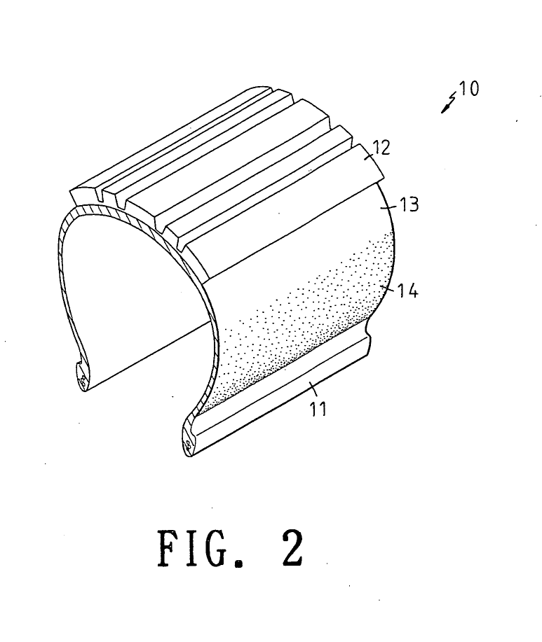

Referring to FIGS. 1 and 2, the tire of the present invention comprises a tread portion 12 with two sidewalls 13 integrally connected to the tread portion 12 and each of the sidewalls 13 includes a lip 11 which is adapted to be engaged with a wheel rim 20. Two reinforcement layers 14 are respectively secured on two respective outsides of the two sidewalls 13 and each reinforcement layer 14 occupies at least ⅔ area of each sidewall 13 and has a smooth outer surface.

Each of the reinforcement layers 14 comprises adhesive and metal particles, or adhesive and mineral particles, or adhesive, metal particles and mineral particles. The reinforcement layers 14 are secure adhered on the sidewalls 13 and the components can effectively prevent from penetration by sharp objects, such as knife, staples, nails and sharp pebbles. The smooth outer surface can easily bounce the pebbles away from the tire 10 and it is improved that staples or nails shot from pneumatic tools cannot penetrate the reinforcement layers 14 if they shoot at an angle relative to the reinforcement layers 14.

While we have shown and described the embodiment in accordance with the present invention, it should be clear to those skilled in the art that further embodiments may be made without departing from the scope of the present invention.

What is claimed is:

1. A tire comprising:
a tread portion with two sidewalls integrally connected to the tread portion and each of the sidewalls includes a lip which is adapted to be engaged with a wheel rim, and
two reinforcement layers respectively secured on two respective outsides of the two sidewalls.

2. The tire as claimed in claim 1, wherein each reinforcement layer comprises adhesive and metal particles.

3. The tire as claimed in claim 1, wherein each reinforcement layer comprises adhesive and mineral particles.

4. The tire as claimed in claim 1, wherein each reinforcement layer comprises adhesive, metal particles and mineral particles.

5. The tire as claimed in claim 1, wherein each reinforcement layer includes a smooth outer surface.

6. The tire as claimed in claim 1, wherein each reinforcement layer occupies at least ⅔ area of each sidewall.
